(19) United States
(12) Patent Application Publication
(10) Pub. No.: US 2018/0374004 A1
(43) Pub. Date: Dec. 27, 2018

(54) PARKING INVENTORY AND RESERVATION MANAGEMENT SYSTEM FOR FLEXIBLE PARKING SUBSCRIPTIONS

(71) Applicants: Jacques Eone, Columbia, MD (US); Laurence Baer, Columbia, MD (US)

(72) Inventors: Jacques Eone, Columbia, MD (US); Laurence Baer, Columbia, MD (US)

(21) Appl. No.: 15/634,730

(22) Filed: Jun. 27, 2017

(51) Int. Cl. G06Q 10/02; G08G 1/14

(52) U.S. Cl. CPC G06Q 10/02; G08G 1/146

(57) ABSTRACT

Various methods and systems for implementing flexible parking subscriptions using a parking inventory and reservation management system are provided. A flexible parking subscription is a hybrid subscription that provides parking patrons with access to longer term parking plans (e.g. monthly) with the flexibility of daily parking options. Generally, a reservation engine manages an inventory pool of parking spaces from one or more participating parking lots using real-time inventory management and on-demand access to lot inventories. Patrons can request assignments from available inventory using a reservation application such as a mobile app or online portal. For example, patrons can request daily assignments for an upcoming week. The reservation engine assigns parking spaces from the inventory pool based on patron requests, available inventory and default assignments. In some embodiments, the system performs usage analytics to predict optimal occupancy levels and/or guaranteed minimum reservations from lots, and can automatically apply the predicted levels and/or guaranteed minimums, for example, on a monthly basis.

### BACKGROUND

Urban parking can be expensive, especially in congested areas and where land values are high. For example, many workers commute to downtown areas in densely populated cities, and many of these commuters drive. Free parking (e.g., offered by employers, cities, businesses, etc.) is frequently unavailable, leaving paid parking as the only option for many people. Other examples of paid parking include travelers paying for airport parking, companies charging employees for parking, and shoppers paying for retail parking. Parking lots generally offer hourly, daily and/or monthly parking options.

### SUMMARY

Embodiments described herein provide methods and systems for managing parking inventory and reservations for flexible parking subscriptions. Generally, a flexible parking subscription provides patrons with access to one or more parking lots in a flexible manner. For example, the subscription may include monthly access to a reservation system that permits patrons to periodically request daily parking assignments for each day of an upcoming plurality of days. In an exemplary embodiment, patrons can request parking assignments for each day in an upcoming week, and parking is assigned at one of the parking lots based on the patron requests.

At a high level, a system for managing parking inventory and reservations for flexible parking subscriptions includes a reservation engine with one or more processors, and memory configured to provide computer program instructions to the one or more processors to perform operations that permit the reservation engine to receive periodic requests for parking assignments, each periodic request comprising a request for a daily parking assignment for each day of an upcoming plurality of days, generate parking assignments based on the periodic requests and available parking spaces in an inventory pool comprising parking spaces from a plurality of parking facilities, and communicate the parking assignments to corresponding parking lots of the plurality of parking facilities.

In some embodiments, the reservation engine can obtain additional parking spaces for the inventory pool by generating an on-demand request for at least one of the plurality of parking facilities. Additionally and/or alternatively, the reservation engine can generate parking assignments based on one or more defaults. The reservation engine can predict an optimal inventory level in the inventory pool for at least one of the plurality of parking facilities and/or predict a guaranteed minimum number of parking spaces to be reserved from at least one of the plurality of parking facilities. In some embodiments, the reservation engine is configured to automatically reserve parking spaces from at least one of the plurality of parking facilities based on at least one of a predicted optimal inventory level in the inventory pool for the at least one parking facility or a predicted guaranteed minimum number of parking spaces to be reserved from the at least one parking facility. The reservation engine can receive requests for day-of parking assignments at one of the plurality of parking facilities and generate parking assignments based on the day-of requests and available parking spaces in the inventory pool.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary parking inventory and reservation management system, in accordance with embodiments described herein;

FIG. 2 is a block diagram of an exemplary reservation engine, in accordance with embodiments described herein;

FIG. 3 is a block diagram of an exemplary lot system, in accordance with embodiments described herein;

FIG. 4 is a block diagram of an exemplary reservation application for use in a parking inventory and reservation management system, in accordance with embodiments described herein;

FIG. 5 is a flow diagram showing an exemplary method for providing a parking inventory and reservation management system, in accordance with embodiments described herein;

FIG. 6 is a flow diagram showing an exemplary method for providing a parking inventory and reservation management system, in accordance with embodiments described herein;

FIG. 7 is a block diagram of an exemplary computing environment suitable for use in implementing embodiments described herein.

### DETAILED DESCRIPTION

Conventional parking subscriptions and associated methods for managing parking inventory and reservations have several shortcomings. For example, many parking patrons require access to multiple parking facilities, such as when patrons work in multiple locations. A lawyer or accountant may work at his or her firm's downtown office some weeks, but travel to client locations other weeks. Similarly, many people travel frequently and require periodic access to airport parking. Generally, however, parking lots do not offer coordinated subscriptions that permit parking patrons to pro-rated fees for reduced usage, or that permit access to multiple parking lots within the same subscription. Not only does this increase costs for parking patrons, but it results in increased complexity in inventory management and reservation systems. For example, patrons may opt for a monthly subscription at a parking lot near their downtown office and purchase parking at daily rates at other lots. Alternatively, patrons may forego a monthly subscription and opt for daily parking at each lot they plan to patronize in a given month. In each of these situations, patrons are required to engage in multiple additional transactions in a given month in lieu of a single monthly transaction. These additional transactions involve resource-intensive processes such as conducting transactions at a point of sale (e.g., by processing cash payments and/or non-cash payments such as debit cards, third party financial products, etc.) and provisioning financial services (e.g., bank payments, credit card payments, etc.), and the like. The operation and maintenance of these processes to conduct additional transactions is time and resource inefficient. Other variations and combinations of shortcomings exist with conventional methods for managing parking inventory and reservations. As such, processes to support flexible parking subscriptions are integral to the deployment of efficient parking inventory and reservation management systems.

Embodiments described herein provide simple and efficient methods and systems for managing parking inventory and reservations for flexible parking subscriptions. At a high level, a parking inventory and reservation management system includes computing systems and associated components—hardware and software—that support a mechanism for a service provider to assign parking spaces to patrons from one or more parking lots. Although embodiments described herein involve parking lots, any parking facility (e.g., any collection, association or configuration of parking spaces or other area assigned for parking, including parking lots, parking garages, carports, parking spaces on the side of the street, automated or semi-automated parking systems, etc.) can be employed within the present disclosure. Based on one or more of a variety of agreements with parking lots, the system maintains an inventory pool of parking spaces. Parking spaces can be reserved in advance for use by the system and/or reserved on-demand (e.g., based on open agreements with lots, overflow agreements, etc.). Generally, patrons subscribe to a flexible parking subscription. For example, the flexible parking subscription can include a monthly plan that includes access to one or more parking lots. Patrons using a reservation application (e.g., an online portal, smart phone app, etc.) can select a desired parking lot and/or parking space for each day, with one or more selections made at a time (e.g., once a week, daily, etc.). The system assigns parking spaces based on patron selections and/or default options. Components located at or otherwise associated with a given parking lot, manage parking space inventory for that lot and control access to the lot based on the assignments.

Generally, a flexible parking subscription is a hybrid parking subscription that includes membership to a parking service for a longer term (e.g., monthly, annual, one-time membership fee, etc.) with the flexibility of a shorter term option (e.g., daily, weekly, etc.). For example, the subscription can include a monthly fee plus a daily rate based on a selected lot and/or a selected parking space. A fixed parking space within a selected parking lot could involve a higher daily rate than general access to a selected lot (i.e., a floating parking space). A patron's selection of a particular lot and/or space for each day is preferably made for multiple days at a time. For example, a patron's selections for a given week are preferably made on a weekly basis. Additionally and/or alternatively, daily fees charged for reservations made in advance might be at one price, while fees charged for same day reservations can include a premium. In this manner, the parking inventory and reservation management system can implement flexible parking subscriptions for parking patrons.

Generally, a parking inventory and reservation management system for flexible parking subscriptions solves the problem of parking patrons working in multiple locations. By way of nonlimiting example, an attorney might normally pay for monthly parking at $250 for a 20 workday month (i.e., $12.50/day). Meanwhile, daily parking might be $25/day. Using embodiments of the present system, by contrast, he or she might pay $15/day (e.g., with no monthly fee, effective rate when including monthly fee and daily usage, etc.) for days where parking is used (e.g., at the office), and pay nothing for days he or she does not need to park (e.g., working days spent in court, at a client location, working remotely, etc.). Such a system can result in potential savings when the patron needs to park less than a given amount of day in the month (e.g., 16*$15/day=$240). In this manner, the process is customer centered and performed in easy steps. In some embodiments, a patron joins the program, and then on a given day (e.g., Sunday), he or she picks the days needed for parking for the upcoming week, and checks out. If, for example, the patron's car is in repair or he or she chooses to go by metro, the patron can save on parking.

The parking inventory and reservation management system can obtain access to parking spaces in any number of ways. For example, various types of agreements can be implemented to rent parking spaces. Such agreements can include open agreements for on-demand access to lot inventories (e.g., for lots with large numbers of unused spaces), open agreements with guaranteed minimums, reserved spaces (e.g., for lots in high demand), hybrid agreements including combinations of various types of agreements, and the like. In some embodiments, overflow agreements can provide on-demand access to additional lot inventory in situations where reserved parking spaces from a desired parking lot have been assigned, and additional spaces are desired. Generally, the parking inventory and reservation management system builds and monitors an inventory pool of available parking spaces (e.g., reserved for system use, monitored unreserved parking spaces available from lot inventories for lots with agreements that allow on-demand access, etc.), assigns parking spaces, and communicates parking assignments to patrons and corresponding lots to facilitate patron access to an assigned lot. Additionally and/or alternatively to renting parking spaces, the system can be used to manage owned parking spaces.

In some embodiments, guaranteed minimums might be offered based on an analysis of past performance and/or predictions for future usage. Accordingly, a guaranteed minimum number of parking spaces to be reserved from a lot can be determined based on one or more algorithms that analyze historical usage (e.g., after a launch period at a particular lot) and/or predict future trends. By way of nonlimiting example, the system can determine an expected usage amount based on an average usage, or a percent thereof, for some defined period (e.g., 75% of the average based on the previous 3 months). Additionally and/or alternatively, the system can account for variations in demand, such as those due to seasonal and/or annual trends, whether past or expected. Similarly, the system can compile location data (e.g., from locations corresponding to daily selections, from locations corresponding to mobile app requests for nearby parking, from surveys of parking patrons regarding expected geographic needs, etc.). In some embodiments, the system can account for predicted changes in historical usage (e.g., based on development or infrastructure projects, planned events, weather patterns, traffic patterns, and the like). Predication algorithms can utilize automated techniques (e.g., using neural networks and machine learning), can accept manual inputs, or some combination thereof. Other variations and combinations of statistical methods for analyzing historical usage and prediction algorithms to predict usage can be implemented and are contemplated within the present disclosure. In some embodiments, the determined minimums are provided to operators and/or administrators to facilitate reservations. Additionally and/or alternatively, the system can automatically guarantee the determined minimum amounts of parking spaces, for example, by automatically reserving the determined minimum amount of parking spaces from participating lots (e.g., on a monthly basis).

The parking inventory and reservation management system works in coordination with a reservation application provided to patrons to accept requests for parking assignments. The reservation application can be provided as an online portal, a mobile app, desktop client, and the like. Generally, the system displays available parking inventory (e.g., unassigned spaces reserved for system use, spaces available from lot inventories for lots with open and/or overflow agreements, etc.). Based on the displayed inventory, patrons can make selections, for example, for each day for an upcoming time period, for a single day, etc. Generally, the system verifies the requested parking space is still available, and if so, records the assignment. For example, the system can update the assignment in a parking space inventory pool and communicate the assignment to a corresponding parking lot so that the patron assigned to that lot can be granted access. In preferred embodiments, when a patron fails to make a selection during a given selection window, a default selection (e.g., determined based on a patron selection made when signing up for a subscription) can be automatically applied. In some embodiments, changes and/or day-of selections can be made (e.g., for an additional and/or premium fee). The system compiles usage and accrued fees for account and billing purposes, and can generate automated bills (e.g., monthly, quarterly, etc.) and/or collect and process payments (e.g., automatically, with patron authorization, etc.). Various accounting, billing and payment systems are known, and are contemplated within the present disclosure. In this manner, system manages parking space inventory in real-time and assigns parking spaces for any number of participating parking lots based on patron selections, default options, parking space inventories and agreements with parking lots.

In some embodiments, a reservation application can be used to locate nearby parking within a patron's subscription. By way of nonlimiting example, a patron device (e.g., a mobile app on a patron smart phone) can determine or facilitate determining the patron's current location (e.g., using an on-board GPS chip or other known ways of determining device location). The patron's current location can be used to determine nearby available parking spaces (e.g., unassigned parking spaces within a certain distance) for display on the patron device. The determination of nearby available parking spaces can include hardware and/or software components located on a patron device, on one or more network components, on site at parking locations, some combination thereof, etc. In an exemplary embodiment, a smart phone app interacts with a remote server that manages parking space inventory and assignments using a client-server configuration to provide indications of available parking spaces overlaid on a map on the client device. The patron can use the reservation application to select an available parking space, request an assignment from the remote server and receive an assignment confirmation from the remote server.

Additionally and/or alternatively, RF transmitters located at parking locations can transmit RF beacon signals indicating parking space availability and location to RF receivers in a patron device. Upon receiving a request at a patron device to identify nearby parking, the patron device can scan for pre-assigned transmitter frequencies, transmitter identifiers (e.g., MAC address), RF signatures (e.g., signal characteristics, coded packets, etc.), and the like. In exemplary embodiments, the transmitters utilize an RF protocol that is compatible with smart phone technology (e.g., cellular protocols, SMS, WiFi, Bluetooth) such that the patron's smart phone can operate as the RF receiver. Preferably, the transmission range is at least a few city blocks (e.g., at least 1-2 miles). By way of nonlimiting example, long-range WiFi technology can be utilized, such as the High Power Wireless-N 600 mW Pro Range Extender manufactured by Amped Wireless®, to communicate with a mobile app on a patron smart phone. Other transmitter-receiver protocols and corresponding hardware can of course be implemented within the present disclosure. When the RF receiver is not a smart phone, preferably the receiver is in communication with one or more components (e.g., a smart phone) capable of displaying nearby available parking spaces, requesting parking assignments from a remote server and receiving an assignment confirmation.

Each participating parking lot can utilize components (hardware and software) that manage its own parking space inventory to control access and determine availability for additional reservations and/or assignments. For example, lots can keep track of parking spaces reserved by the system (whether assigned or not), assigned parking spaces (whether assigned by the system or otherwise) and unreserved, unassigned parking spaces. In some embodiments, scanning and/or sensor systems can be employed to determine, in real time, which parking spaces are occupied and which are open. Various types of known sensor systems (e.g., infrared, induction, magnetic, piezoelectric, pressure, motion, radar, acoustic, RFID, video image processing, etc.) can be employed for this purposes and are contemplated within the present disclosure. Such occupancy information can be broadcast, for example, at parking lot entrances, select locations in or around the parking lot, individual parking spaces, etc.

Parking lots such as those with open or overflow relationships preferably provide a list or other indication of unreserved and/or unoccupied parking spaces for monitoring by the system. In this way, if a lot receives an on-demand request (e.g., from the system requesting an overflow reservation or assignment), the lot can update its parking space inventory and communicate any updates to facilitate real-time inventory monitoring and management. Additionally and/or alternatively, parking space scanning and/or sensor systems can be dedicated or otherwise assigned to monitoring the occupancy of reserved parking spaces. Such occupancy information can be provided, for example, to reduce the risk of a participating parking lot assigning an unauthorized vehicle to a reserved parking space. Similarly such occupancy information indicating an unauthorized use can be employed to generate an alert for parking lot and/or system operators to enable quick resolution.

Parking lots generally control access based on parking assignments. For example, patrons on site can input access credentials (e.g., keypad entry, RFID, bar codes, smart cards, voice recognition, biometric technologies optical recognition, etc.) to request access. If a patron is authorized to park at the lot (e.g., has been assigned a fixed or floating parking space, has been issued an entry ticket, etc.), the lot can grant access, for example, using a controlled gate.

As such, management of parking inventory and reservations can be achieved based on flexible parking subscriptions, patron reservation applications, real-time inventory management, on-demand access to lot inventories, usage analytics and automated lot relationship management.

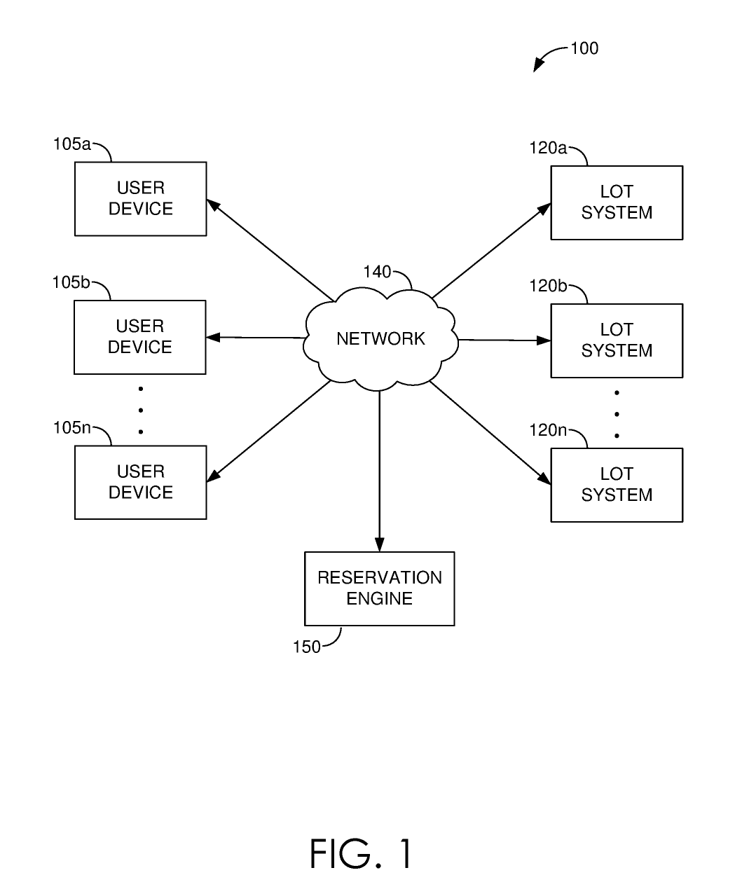

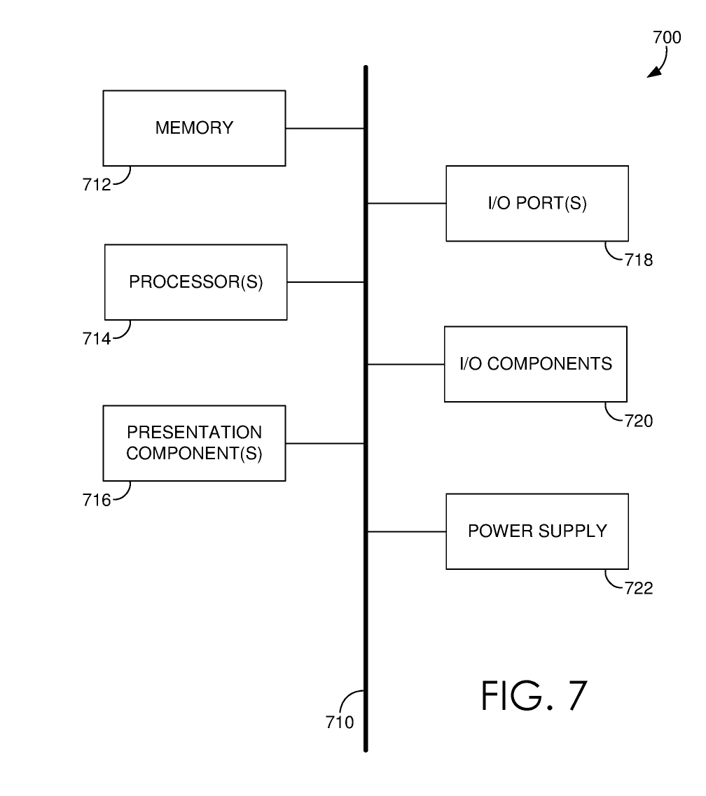

With reference to FIG. 1, embodiments of the present disclosure can be discussed with reference to an exemplary computing environment (such as exemplary computing environment 700 of FIG. 7) that serves as an operating environment for implementing the functionality described herein with respect to exemplary parking inventory and reservation management system 100. A system, as used herein, refers to any device, process, or service or combination thereof. A system may be implemented using components as hardware, software, firmware, a special-purpose device, or any combination thereof. A system may be integrated into a single device or it may be distributed over multiple devices. The various components of a system may be co-located or distributed. The system may be formed from other systems and components thereof. It should be understood that this and other arrangements described herein are set forth only as examples.

Parking inventory and reservation management system 100 includes user devices 105a, 105b, . . . , 105n, lot systems 120a, 120b, . . . , 120n, network 140 and reservation engine 150. Generally, reservation engine 150 manages a parking space inventory pool. For example, the inventory pool can include parking spaces rented and/or owned from parking lots operating lots systems 120a, 120b, . . . , 120n, as described in more detail herein. Reservation engine 150 can be implemented as one or more computing devices such as server. Reservation engine 150 accepts requests for parking assignments from patrons utilizing user devices 105a, 105b, . . . , 105n. Generally, patrons with subscriptions utilize user devices 105a, 105b, . . . , 105n to access the parking space inventory pool and request parking assignments from reservation engine 150. When a requested parking space is available (e.g., reserved by the system and unassigned, available via an open agreement with a parking lot, available via an overflow agreement, etc.), reservation engine 150 records a parking assignment by updating the inventory pool, confirming the assignment with the patron and/or communicating the assignment to the corresponding lot system 120a, 120b, . . . , 120n. Reservation engine 150 can also manage patron subscriptions, perform usage analytics, perform location determinations and compile usage for accounting and billing. The components of parking inventory and reservation management system 100 may communicate with each other via a network 140, which may include, without limitation, one or more local area networks (LANs) and/or wide area networks (WANs). Such networking environments are commonplace in offices, enterprise-wide computer networks, intranets, and the Internet.

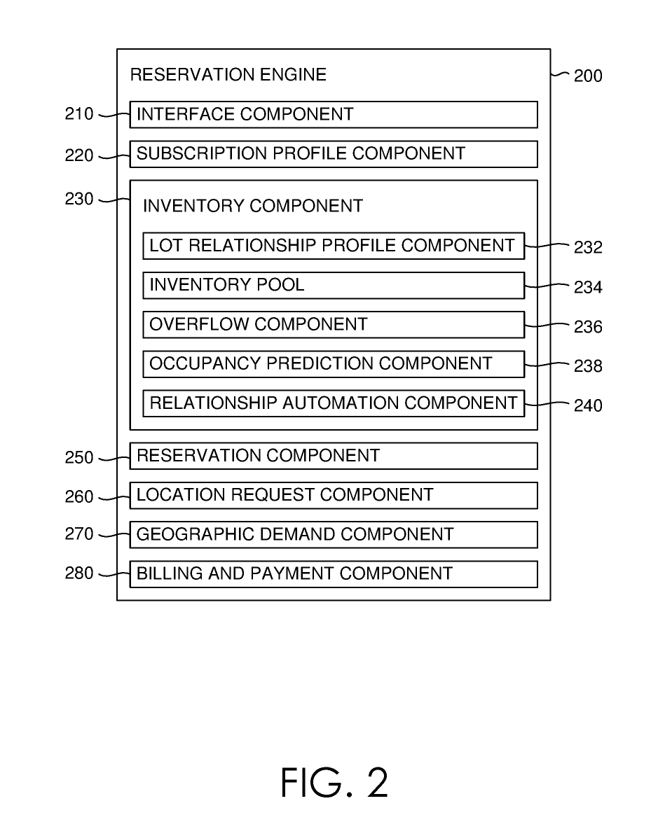

With reference to FIG. 2, FIG. 2 depicts an exemplary reservation engine in accordance with embodiments described herein. Reservation engine 200 includes interface component 210, subscription profile component 220, inventory component 230, reservation component 250, location request component 260, geographic demand component 270 and billing and payment component 280. Reservation engine 200 is preferably implemented as one or more servers, but can be implemented across any number of computing devices, including user devices 105a, 105b, . . . , 105n, lot systems 120a, 120b, . . . , 120n, or otherwise.

In the embodiment depicted in FIG. 2, subscription profile component 220 manages patron parking subscriptions. For example, each patron can subscribe to a flexible parking service, upon which subscription profile component 220 creates and maintains a subscription profile for each patron. Subscription profile component 220 can include or otherwise associate various types of subscriber information with patron subscription profiles, such as identification information (e.g., name, user ID, password, user device IDs, etc.), account information (type of account, accrued fees, payment status, etc.), billing information (payment methods, address, etc.), default selections (e.g., a preferred parking lot and/or parking space, preferred selections for a given time period, etc.), survey questions (e.g., information regarding where a patron most often needs to park, etc.), and the like. In some embodiments, subscription profile component 220 compiles and/or stores patron usage and/or fee accruals in the subscription profiles, or otherwise associates usage with the profiles, and can provide access to billing and payment component 280 for bill generation and payment processing.

In the embodiment depicted in FIG. 2, inventory component 230 includes lot relationship profile component 232, inventory pool 234, overflow component 236, occupancy prediction component 238 and relationship automation component 240. Lot relationship profile component 232 creates and maintains lot relationship profiles for each participating parking lot. As described above, various types of lot agreements can be implemented, including open agreements, open with guarantee, reserved spaces, hybrid and overflow agreements. In this manner, lot relationship profile component 232 can store the type of agreement in, or associate it with corresponding lot relationship profiles. More generally, lot relationship profile component 232 can store or associate lot information and access information (e.g., names, device IDs, device addresses, credentials, etc.), lot account information (type of account, accrued fees by the system, payment status, etc.), payment information (payment methods, authorizations, etc.), and the like. In the embodiment depicted in FIG. 2, lot relationship profile component 232 maintains lot relationship profiles for use by inventory pool 234, overflow component 236, occupancy prediction component 238, relationship automation component 240 and reservation component 250.

Generally, inventory component 230 manages inventory pool 234 for the parking inventory and reservation management system. By way of nonlimiting example, assume lot A's inventory is available by open agreement. Preferably, inventory component 230 can access and monitor lot A's inventory in real-time for inclusion in inventory pool 234. In this manner, inventory component 230 can access lot A's relationship profile (e.g., via lot relationship component 232), access lot A's account information from its profile, determine an open agreement is in place and communicate with lot A's system (e.g., via interface component 210) to include lot A's inventory in inventory pool 234. Similarly, assume lot B's inventory is available by overflow agreement. Preferably, inventory component 230 can access and monitor lot B's overflow inventory in real-time to issue on-demand requests to reserve additional parking spaces for inclusion in inventory pool 234. In this manner, inventory component 230 and/or overflow component 236 can access lot B's relationship profile (e.g., via lot relationship component 232), access lot B's account information from its profile, determine an overflow agreement is in place and communicate with lot B's system (e.g., via interface component 210) to reserve additional spaces from lot B's inventory for inclusion in inventory pool 234 and/or for assignment. In these situations, subscription profile component 220 can update the corresponding lot relationship profile to reflect the parking assignments and/or reservations.

In some embodiments, occupancy prediction component 238 predicts occupancy levels for each lot based on prior usage, which can be stored in or associated with a corresponding lot relationship profile. For example, occupancy prediction component 238 can assign a probability to different occupancy levels using known statistical methods based, for example, on historical usage over defined periods. Based on a predetermined or learned threshold probability, occupancy prediction component 238 can propose optimal levels of inventory for each participating lot. Generally, occupancy prediction component 238 can utilize various statistical methods for analyzing historical usage and prediction algorithms, as described herein.

In some embodiments, occupancy prediction component 238 can apply the proposed optimal inventory levels to participating parking lot accounts (e.g., taking into account parking rates, past or projected revenues/profits, predetermined/learned margins, etc.) and propose how many spaces to rent at each lot. Additionally and/or alternatively, occupancy prediction component 238 can determine a guaranteed minimum usage for a given lot. The determined optimal levels and/or guaranteed levels can be provided to an administrator or other authorized user to manage lot relationships and update the corresponding lot relationship profiles (e.g., via a terminal that provides access to reservation engine 200). In some embodiments, relationship automation component 240 can automatically apply the proposed optimal inventory levels and/or guaranteed minimums to existing relationships. For example, relationship automation component 240 can automatically update the amount of parking spaces reserved for or guaranteed to a particular lot, e.g., on a monthly basis. In these situations, subscription profile component 220 can update the corresponding lot relationship profile and inventory component 230 can update inventory pool 234 to reflect any updated parking space reservations and/or assignments.

Reservation component 250 generally assigns parking spaces from inventory pool 234 and/or via overflow agreement. For example, patrons requesting access to inventory pool 234 can communicate with reservation component 250 (e.g., via interface component 210) to access a list or other representation of available parking spaces (e.g., reserved and unassigned parking spaces, parking spaces available by open agreement or overflow agreement, etc.), and to request and receive parking assignments. In this manner, reservation component 250 receives a request for an inventory listing, accesses inventory pool 234, provides a list or other representation of the available inventory in inventory pool 234 to the requesting patron, receives a request for one or more parking assignments (whether fixed or floating), assigns the requested parking space from inventory pool 234 and/or via overflow agreement, confirms the assignment with the requesting patron, and communicates the assignment for updating in inventory pool 234, the patron's subscriber profile and the corresponding lot inventory.

Generally, reservation component 250 and/or a reservation application on a patron device can implement a flexible parking subscription. In embodiments, the flexible parking subscription permits patrons to request daily assignments in advance (e.g., in one week blocks). Accordingly, reservation component 250 and inventory pool 234 accommodate advance booking. In some embodiments, reservation component 250 includes a periodic (i.e., recurring, whether or not in fixed intervals) selection window for some predefined duration (such as one day per week, before a defined deadline, etc.), within which patrons can request daily assignments for the week. In preferred embodiments, the parking inventory and reservation management system assigns parking on a first-come, first-served basis, however, other variations can be implemented (e.g., lottery, bidding system, preferred status for premium paying patrons, etc.). If after a selection window has passed, a patron has not requested or otherwise been assigned his or her weekly assignments, reservation component 250 can apply default assignments (e.g., based on default selections stored in or associated with the patron's subscription profile).

In some embodiments, the parking inventory and reservation management system also supports day-of requests for parking assignments. For example, a patron searching for day-of parking may send a request to reservation component 250 and/or location request component 260 (e.g., via interface component 210) to identify available parking spaces in proximity to a particular location (e.g., the closest space available to the patron's current location). For example, a patron using a mobile device can include the patron's location in the request. Generally, location algorithms used to identify a patron's location can be implemented on the patron's mobile device, some remote component such as location request component 260, or some combination thereof. Location request component 260 can identify a subset of inventory pool 234 in proximity to the patron's location. For example, a default proximity (such as a square mile centered at the patron's location) can be applied to retrieve a relevant subset of parking space inventory. Similarly, the patron can provide a requested geographic area (e.g., by sizing and centering a map displayed on the patron's device). In this manner, reservation component 250 and/or location request component 260 can retrieve a corresponding subset of available inventory and provide an indication of the inventory in that region to the patron device. The patron can then request an assignment (e.g., via reservation component 250) based on the available inventory.

In some embodiments, geographic demand component 270 determines geographical trends in demand. For example, geographic demand component 270 can compile location data such as locations from requests for nearby parking spaces, locations of default parking selections stored in or associated with subscription profiles, and/or most often needed locations stored in or associated with subscription profiles. Geographic demand component 270 can utilize location data to facilitate projecting quantities of new spaces to book in nearby lots. For example, geographic demand component 270 can provide data visualizations of location data to authorized users (e.g., via a terminal that provides access to reservation engine 200). Additionally and/or alternatively, geographic demand component 270 can coordinate with occupancy prediction component 238 and/or relationship automation component 240 to predict optimal occupancy levels, predict guaranteed minimums and/or apply these determinations to ongoing relationships.

Billing and payment component 280 generally accesses patron usage (e.g., stored in association with the patron's subscription profile) to generate bills and process payments. Various methods for billing and payment are known and contemplated within the present disclosure.

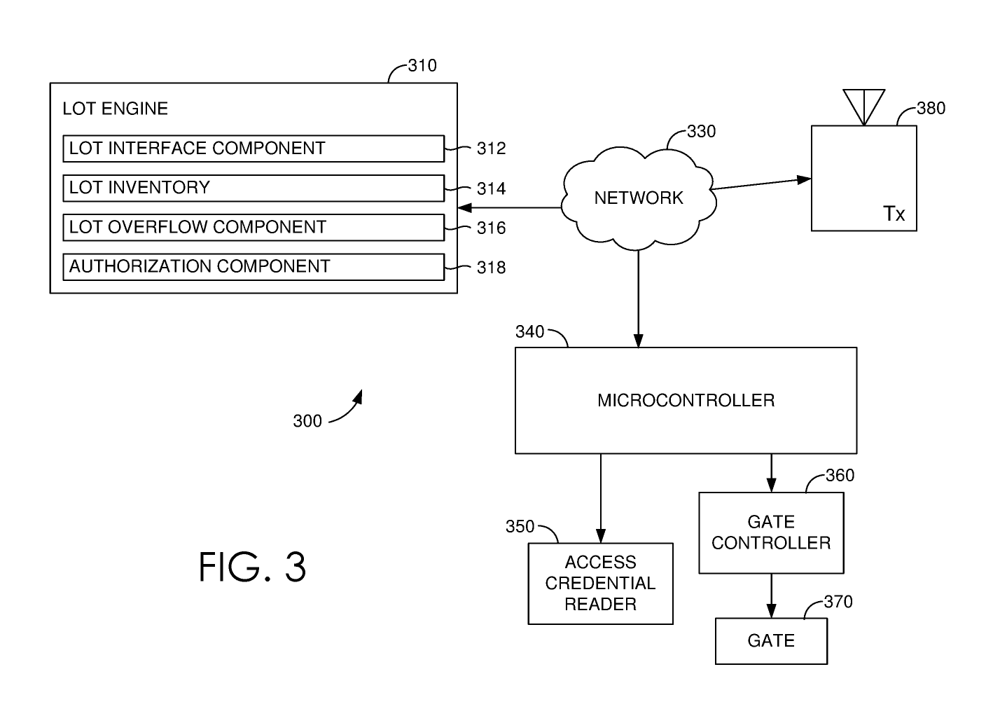

With reference to FIG. 3, FIG. 3 depicts exemplary lot system 300. Lot system 300 includes lot engine 310, network 330, microcontroller 340, access credential reader 350, gate controller 360, gate 370 and RF transmitter 380. The components of lot system 300 may communicate with each other via a network 330, which may include, without limitation, one or more local area networks (LANs) and/or wide area networks (WANs). Such networking environments are commonplace in offices, enterprise-wide computer networks, intranets, and the Internet. Network 330 may but need not be the same as network 140 of FIG. 1.

Lot engine 310 includes lot interface component 312, lot inventory 314, lot overflow component 316 and authorization component 318. Generally, lot engine 310 manages lot inventory 314 in accordance with the lot's corresponding relationship agreement, preferably in real-time. By way of nonlimiting example, for open relationships, lot interface component 312 makes lot inventory 314 available to reservation engine 200 (e.g., via interface component 210). For overflow relationships, lot overflow component 316 accepts overflow requests from reservation engine 200 for overflow reservations and/or assignments. Generally, lot engine 310 updates lot inventory 314 to reflect any reservations and assignments (e.g., from reservation engine 200), and for assignments, lot engine 310 records corresponding patron information (e.g., using lot inventory 314 and/or authorization component 318).

Generally, when a patron (e.g., a subscriber to the flexible subscription) seeks access to lot system 300, the patron approaches access credential reader 350 and gate 370. Preferably, access credential reader 350, gate controller 360, gate 370 and microcontroller 340 are collocated. The patron inputs access credentials using access credential reader 350 (e.g., keypad entry, RFID, bar codes, smart cards, voice recognition, biometric technologies optical recognition, etc.). Microcontroller 340 accesses the credentials from access credential reader 350 and facilitates an authorization check. Software to accomplish this authorization can be included in lot engine 310 (e.g., authorization component 318), programmed in memory, or some combination thereof. If the patron has been assigned a parking space at lot 300 using reservation engine 200, the assignment and corresponding credentials will be recorded in lot engine 310 and/or memory in microcontroller 340. Microcontroller 340 can access the stored credentials (or provide the input credentials to lot engine 310) for an authorization determination. If the patron is authorized to access lot system 300, microcontroller 340 commands gate controller 360 (e.g., one or more relays used to control a gate motor/hydraulics, stepper motor, servo, etc.) to open gate 370. In this manner, a patron with an assignment at lot 300 can be granted access via gate 370.

In some embodiments, lot 300 can include RF transmitter 380. RF transmitter 380 provides an alternative channel for communicating parking space availability to patrons with devices that include RF receivers. For example, RF transmitter 380 can transmit an RF beacon with its location and an indication of parking space availability to nearby patrons. For example, RF transmitter 380 can transmit at one or more pre-determined frequencies and can include an identifier (e.g., MAC address) and/or characteristic RF signature for identification (e.g., signal characteristics, coded packets, etc.), and the like. Various methods for encoding data (e.g., beacon location and parking space availability) onto RF signals are known and contemplated within the present disclosure. Preferably, RF transmitter 380 utilizes an RF protocol that is compatible with a smart phone (e.g., cellular protocols, SMS, WiFi, Bluetooth) such that the patron's smart phone antenna operates as the RF receiver.

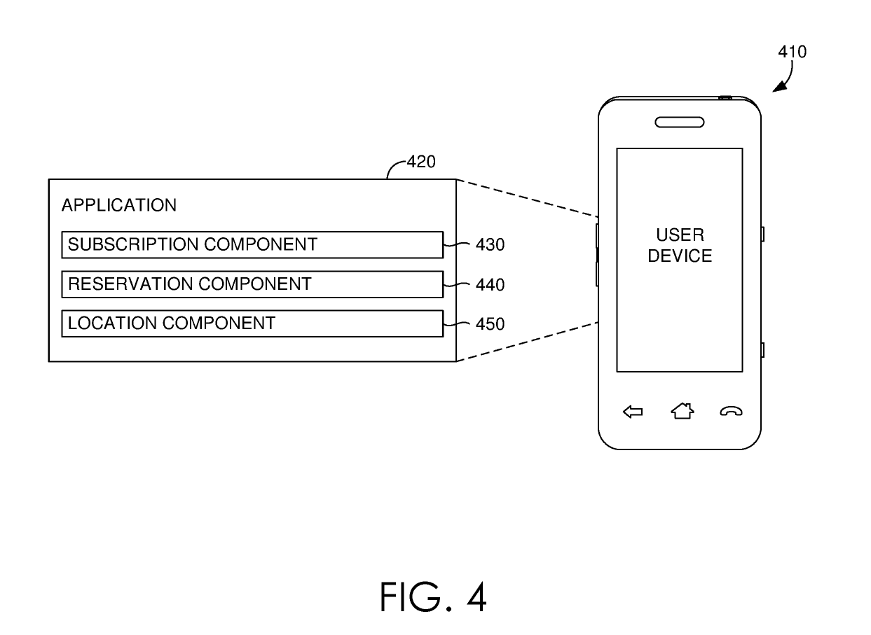

With reference to FIG. 4, FIG. 4 depicts an exemplary reservation application 420 on user device 410. Reservation application 420 can be a mobile app, an online portal or a desktop client, to name a few examples. Although user device 410 is depicted as a smart phone, this need not be the case, and other user devices are contemplated within the present disclosure. Generally, reservation application 420 can operate as a client in communication with a server such as reservation engine 200 to provide a user interface for a patron to request to view available parking spaces, request and confirm parking assignments, and provide payment.

Generally, reservation application 420 includes subscription component 430, reservation component 440, and location component 450. Subscription component 430 manages the patron's credentials and facilitates payment processing. For example, when a patron logs into application 420, subscription component 430 can establish a connection with reservation engine 200 using the patron's credentials. Similarly, subscription component 430 can store payment information, receive payment authorization from the patron and provide payment authorization to reservation 200. Reservation component 440 of application 420 on user device 410 interfaces with reservation component 250 of reservation engine 200 to receive patron requests to view available inventory, retrieve and display the available inventory, receive patron requests for parking assignments, provide confirmations of successful assignments and display past and future assignments.

Reservation component 440 can provide a selection window for the patron to request assignments for a single day (e.g., day-of, future days) and/or a block of days (e.g., weekly). For example, reservation component 440 can request available parking inventory from reservation engine 200 by providing a desired location such as the patron's current location. In this manner, location component 450 can be used (singularly or in combination with reservation engine 200) to determine the patron's location. By way of nonlimiting example, location component 450 can request a location determination using the internal capabilities of user device 410 (e.g., GPS, WiFi, etc.). In response to providing the patrons location to reservation engine 200, reservation engine 200 can reply with an indication of nearby available parking for display to the patron. In some embodiments, reservation component 440 interfaces with a coupled RF antenna (e.g., of user device 410) to scan for beacons transmitting parking space location and availability for display to the patron. In this manner, the patron can use reservation component 440 of application 420 to request a parking assignment from reservation engine 200.

Having identified various components of a parking inventory and reservation management system, it is noted that any number of components may be employed to achieve the desired functionality within the scope of the present disclosure. The various components of FIGS. 1-4 are shown with lines for the sake of conceptual clarity, and other arrangements of the described components and/or component functionality are also contemplated. For example, although some components of FIGS. 1-4 are depicted as single components, the depictions are exemplary in nature and in number and are not to be construed as limiting for all implementations of the present disclosure. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

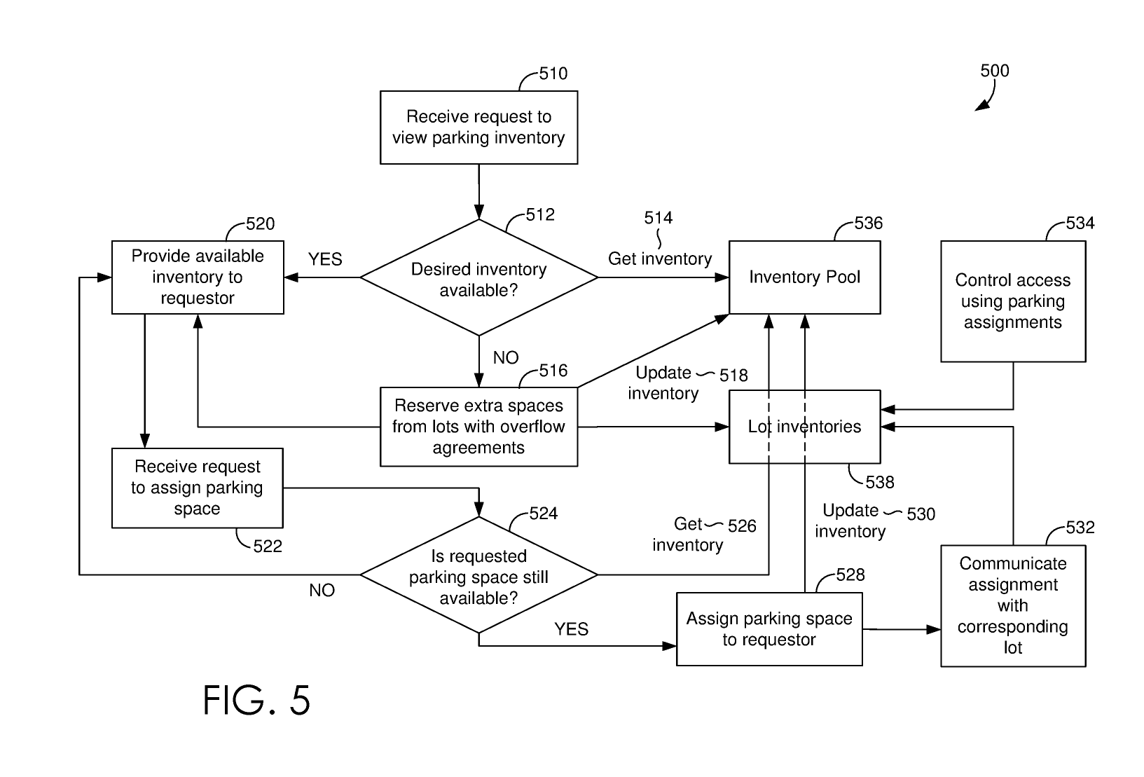

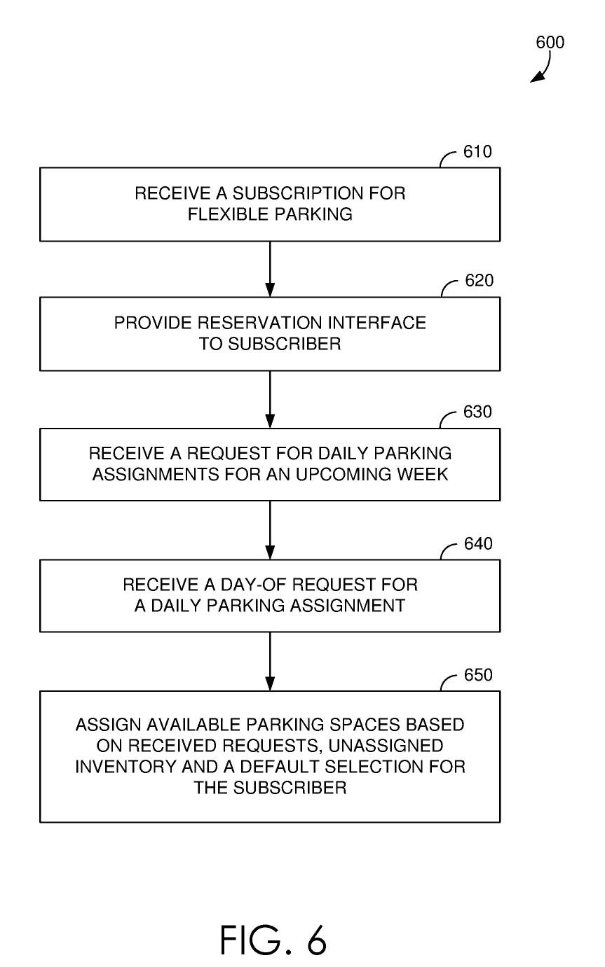

With reference to FIGS. 5 and 6, flow diagrams are provided illustrating methods for managing parking inventory and reservations. The methods can be performed using the parking inventory and reservation management system described herein. In embodiments, one or more computer storage media having computer-executable instructions embodied thereon can, when executed by one or more processors, cause the one or more processors to perform the methods in the parking inventory and reservation management system.

Turning now to FIG. 5, a flow diagram is provided that illustrates a method 500 for providing parking inventory and reservation management. Initially at block 510, a request to view parking inventory is received. At block 512, a determination is made whether there are desired parking spaces available in inventory pool 536 by checking available inventory at 514. In some embodiments, parking spaces in inventory pool 536 include parking spaces available via one or more open agreements. At block 516, extra parking spaces can be reserved from lot inventories 538 for lots with overflow agreements, and inventory pool 536 can be updated accordingly at 518. Once there are desired parking spaces available in inventory pool 536 (either at determination 512 or as a result of reservations made at block 516), available inventory is provided to the requestor at block 520. At block 522, a request for a parking assignment is received. In the event that the available inventory has changed between the time it was provided to the requestor and the time a request for an assigned parking space is received, at block 524, a determination is made whether the requested parking space is still available in inventory pool 536 by checking available inventory at 526. If the requested parking space has already been assigned, the requestor can be informed, and the method returns to block 520. If the requested parking space is still available, the parking space is assigned to the requestor at block 528, and inventory pool 536 is updated at 530. At block 532, the assignment is communicated with the corresponding lot, and the corresponding lot inventory 538 is updated. In this manner, lots control access at block 534 using parking assignments.

Turning now to FIG. 6, a flow diagram is provided that illustrates a method 600 for providing parking inventory and reservation management. Initially at block 610, a subscription for flexible parking is received. At block 620, a reservation interface is provided to the subscriber, for example, using a mobile app or online portal. At block 630, a request for daily parking assignments is received for an upcoming week. At block 640, a day-of request for a daily parking assignment is received. Accordingly, at block 650, available parking spaces are assigned based on received requests, available inventory and a default selection for the subscriber.

Having briefly described an overview of embodiments of the present invention, an exemplary operating environment in which embodiments of the present invention may be implemented is described below in order to provide a general context for various aspects of the present invention. Referring initially to FIG. 7 in particular, an exemplary operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 612 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

With reference to the parking inventory and reservation management system, embodiments described herein support management of parking inventory and reservations. The parking inventory and reservation management system components refer to integrated components for management of parking inventory and reservations. The integrated components refer to the hardware architecture and software framework that support the disclosed functionality within the system. The hardware architecture refers to physical components and interrelationships thereof and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the system components can manage resources and provide services for system functionality. Any other variations and combinations thereof are contemplated with embodiments of the present invention.

By way of example, the parking inventory and reservation management system can include an API library that includes specifications for routines, data structures, object classes, and variables may support the interaction between the hardware architecture of the device and the software framework of the parking inventory and reservation management system. These APIs include configuration specifications for the parking inventory and reservation management system such that the different components therein can communicate with each other in the parking inventory and reservation management system, as described herein.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to an exemplary computing environment; however the computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the parking inventory and reservation management system and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A system for managing parking inventory and reservations for flexible parking subscriptions, the system comprising:
a reservation engine comprising:
one or more processors; and
memory configured to provide computer program instructions to the one or more processors to perform operations that permit the reservation engine to:
receive periodic requests for parking assignments, each periodic request comprising a request for a daily parking assignment for each day of an upcoming plurality of days;
generate parking assignments based on the periodic requests and available parking spaces in an inventory pool comprising parking spaces from a plurality of parking facilities; and
communicate the parking assignments to corresponding parking facilities of the plurality of parking facilities.

2. The system of claim 1, wherein the reservation engine is additionally configured to obtain additional parking spaces for the inventory pool by generating an on-demand request for at least one of the plurality of parking facilities.

3. The system of claim 1, wherein the reservation engine is additionally configured to generate parking assignments based on one or more defaults.

4. The system of claim 1, wherein the reservation engine is additionally configured to predict an optimal inventory level in the inventory pool for at least one of the plurality of parking facilities.

5. The system of claim 1, wherein the reservation engine is additionally configured to predict a guaranteed minimum number of parking spaces to be reserved from at least one of the plurality of parking facilities.

6. The system of claim 1, wherein the reservation engine is additionally configured to automatically reserve parking spaces from at least one of the plurality of parking facilities based on at least one of a predicted optimal inventory level in the inventory pool for the at least one parking facility or a predicted guaranteed minimum number of parking spaces to be reserved from the at least one parking facility.

7. The system of claim 1, wherein the reservation engine is additionally configured to receive requests for day-of parking assignments at one of the plurality of parking facilities and generate parking assignments based on the day-of requests and available parking spaces in the inventory pool.

8. A computer-implemented method for managing parking inventory and reservations for flexible parking subscriptions, the method comprising:
periodically receiving a request for a plurality of daily parking assignments for each day of an upcoming plurality of days, each requested daily parking assignment being to park at one of one or more parking facilities;
generating parking assignments based on the request and available parking spaces in an inventory pool comprising parking spaces from the one or more parking facilities;
communicating the parking assignments to corresponding parking facilities of the one or more parking facilities; and
controlling access to the corresponding parking facilities based on the parking assignments.

9. The method of claim 8, additionally comprising obtaining additional parking spaces for the inventory pool by generating an on-demand request for one of the one or more parking facilities.

10. The method of claim 8, additionally comprising generating parking assignments based on one or more defaults.

11. The method of claim 8, additionally comprising predicting an optimal inventory level in the inventory pool for at least one parking facility.

12. The method of claim 8, additionally comprising predicting a guaranteed minimum number of parking spaces to be reserved from at least one parking facility.

13. The method of claim 8, additionally comprising automatically reserving parking spaces from at least one parking facility based on at least one of a predicted optimal inventory level in the inventory pool for the at least one parking facility or a predicted guaranteed minimum number of parking spaces to be reserved from the at least one parking facility.

14. The method of claim 8, additionally comprising receiving requests for day-of parking assignments at one of the one or more parking facilities and generating parking assignments based on the day-of requests and available parking spaces in the inventory pool.

15. One or more computer storage media having computer-executable instructions embodied thereon that, when executed, by one or more processors, causes the one or more processors to perform a method for managing parking inventory and reservations for flexible parking subscriptions, the method comprising:
periodically receiving requests for a plurality of daily parking assignments for each day of an upcoming plurality of days, each requested daily parking assignment being to park at one of one or more parking facilities;
generating parking assignments based on the requests and available parking spaces in an inventory pool comprising parking spaces from the one or more parking facilities;
communicating the parking assignments to corresponding parking facilities of the one or more parking facilities; and
automatically reserving parking spaces from at least one parking facility based on at least one of a predicted optimal inventory level in the inventory pool for the at least one parking facility or a predicted guaranteed minimum number of parking spaces to be reserved from the at least one parking facility.

16. The media of claim 15, wherein the method additionally comprises obtaining additional parking spaces for the inventory pool by generating an on-demand request for one of the one or more parking facility.

17. The media of claim 15, wherein the method additionally comprises generating parking assignments based on one or more defaults.

18. The media of claim 15, wherein the method additionally comprises receiving requests for day-of parking assignments at one of the one or more parking facilities and generating parking assignments based on the day-of requests and available parking spaces in the inventory pool.

19. The media of claim 18, wherein the method additionally comprises providing a subset of available parking spaces in the inventory pool determined to be located within a defined distance of a requested location.

20. The media of claim 15, wherein each of the one or more parking facilities includes an access controller configured to grant access to the parking facility based on the parking assignments.
